(19) United States
(12) Patent Application Publication
(10) Pub. No.: US 2026/0337374 A1
(43) Pub. Date: Oct. 29, 2026

(54) SILICONE COMPOSITION AND METHOD OF MAKING

(71) Applicant: SAINT-GOBAIN PERFORMANCE PLASTICS CORPORATION, Malvern, PA (US)

(72) Inventors: Shuai LIANG, Southborough, MA (US); Cassandra T. TUBBS, Boylston, MA (US); Elizabeth Grace TOWLE, Worcester, MA (US); Zichao WEI, Brighton, MA (US); Nicolas DROLET, Chelmsford, MA (US)

(21) Appl. No.: 19/658,137

(22) Filed: Apr. 24, 2026

Related U.S. Application Data
(60) Provisional application No. 63/794,813, filed on Apr. 25, 2025.

(51) Int. Cl. C08K 3/36; C08G 77/12; C08G 77/442

(52) U.S. Cl. CPC C08K 3/36; C08G 77/12; C08G 77/442

(57) ABSTRACT

The subject application relates to a silicone composition, an article, and method of making. The silicone composition includes at least one organosiloxane; at least one bio-based oil reactive with the at least one organosiloxane; and at least one filler.

### CROSS-REFERENCE TO RELATED APPLICATION(S)

This application claims priority under 35 U.S.C. § 119 (e) to U.S. Provisional Patent Application No. 63/794,813 entitled “SILICONE COMPOSITION AND METHOD OF MAKING,” filed Apr. 25, 2025, by Shuai LIANG et al., which is assigned to the current assignee hereof and is incorporated herein by reference in its entirety.

### FIELD OF THE DISCLOSURE

This disclosure, in general, relates to a silicone composition and method of forming the silicone composition.

### BACKGROUND

Silicone-containing polymeric materials are widely used for their properties desired in the medical, pharmaceutical, food, and biological industries. For instance, silicone-containing polymeric materials typically are non-toxic, flexible, thermally stable, have low chemical reactivity, and can be produced in a variety of sizes. Typical commercial formulations of liquid silicone rubber (LSR) compositions include a multi-component mixture of a vinyl-containing polydiorganosiloxane, a hydrogen-containing polydiorganosiloxane, catalyst, crosslinker, and filler. Often, the commercial formulation is a two-part formulation that is mixed together prior to use. Once the commercial formulation is mixed, the silicone formulation is subsequently molded or extruded and vulcanized. With polymeric materials, the widespread use creates issues with consumption, waste, and environmental considerations.

Accordingly, it would be advantageous to decrease the carbon footprint when producing silicone-containing polymeric materials. Furthermore, a lower carbon footprint silicone-based tube is desired that has advantageous mechanical and physical properties.

### SUMMARY

In an embodiment, a silicone composition includes at least one organosiloxane; at least one bio-based oil reactive with the at least one organosiloxane; and at least one filler.

In an embodiment, a method of providing an article includes a silicone composition including: providing at least one organosiloxane; at least one bio-based oil reactive with the at least one organosiloxane; and at least one filler; and shaping the silicone composition into an article.

In an embodiment, an article includes at least one layer of a silicone composition, wherein the silicone composition includes at least one organosiloxane; at least one bio-based oil reactive with the at least one organosiloxane; and at least one filler.

In another embodiment, a tube comprising a silicone composition, the silicone composition including at least one organosiloxane; at least one bio-based oil reactive with the at least one organosiloxane, wherein the bio-based oil includes a soybean oil and a castor oil; and at least one filler.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube.

The use of the same reference symbols in different drawings indicates similar or identical items.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof, are open-ended terms and should be interpreted to mean “including, but not limited to . . . ”. These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 25 °C. For instance, values for viscosity are at 25 °C, unless indicated otherwise.

In a particular embodiment, a silicone composition is provided. The silicone composition includes at least one organosiloxane and at least one bio-based oil reactive with the organosiloxane. “Reactive with the organosiloxane” as used herein refers to a bio-based oil that reacts with the at least one organosiloxane to form a covalent bond between the at least one organosiloxane and the bio-based oil to form a polymeric chain, i.e., resulting in a silicone polymer. In an embodiment, the silicone composition further includes a filler. The silicone composition including the bio-based oil advantageously provides a desirable article having a carbon dioxide emission that is decreased significantly compared to a silicone composition absent the bio-based oil. Further, desirable mechanical properties are achieved with the use of the bio-based oil.

In an embodiment, the silicone composition includes at least one organosiloxane. Any organosiloxane is envisioned. In an embodiment, the at least one organosiloxane includes, for instance, a hydride-containing alkylsiloxane, a vinyl-containing alkylsiloxane, an aryl-containing alkylsiloxane, a hydroxy-containing alkylsiloxane, a halogen-containing alkylsiloxane, or combination thereof. In an embodiment, the at least one organosiloxane may include any alkyl group, such as any C1-6 alkyl group or combination thereof. In an embodiment, the aryl group of the aryl-containing alkylsiloxane may include any number of carbon groups such as 3 to 12 aryl groups. In an embodiment, exemplary organosiloxanes include, for instance, a dimethylsiloxane, a diethylsiloxane, a dipropylsiloxane, a methylethylsiloxane, a methylpropylsiloxane, or combinations thereof.

In an example, the at least one organosiloxane may include a halide functional group, a phenyl functional group, or combination thereof. For example, the at least one organosiloxane may include a fluorine group or a phenyl group. Alternatively, the at least one organosiloxane is non-polar and is free of a halide functional group, such as chlorine and fluorine, and of a phenyl functional group.

In an embodiment, the at least one organosiloxane is present at 50 to 85 wt. %, such as 55 to 80 wt. %, or even 60 to 75 wt. % of the total weight of the silicone composition. In a more particular embodiment, the at least one organosiloxane is present at an amount of at least 50 wt. %, or at least 52 wt. %, or at least 54 wt. %, or at least 56 wt. %, or at least 58 wt. %, or at least 60 wt. %, or not greater than 85 wt. %, or not greater than 84 wt. %, or not greater than 82 wt. %, or not greater than 80 wt. %, or not greater than 78 wt. %, or not greater than 75 wt. % of the total weight of the silicone composition. It will be appreciated that the amount of the at least one organosiloxane can be within a range between any of the minimum and maximum values noted above.

In an embodiment, the silicone composition includes the at least one bio-based oil that is reactive with the at least one organosiloxane to form the silicone polymer. Any bio-based oil is envisioned. “Bio-based oil” as used herein refers to any reasonable oil that is derived from a plant. In an embodiment, the bio-based oil includes a soybean oil, a castor oil, a macadamia nut oil, a palm kernel oil, an olive oil, a sunflower oil, a canola oil, a safflower oil, or combination thereof. In a more particular embodiment, the bio-based oil is a soybean oil, a castor oil, or combination thereof.

In an embodiment, the bio-based oil is functionalized with a functional group. Any functional group is envisioned that reacts with the at least one organosiloxane. In an embodiment, the functional group can react with at least two organosiloxanes. In an embodiment, the functional group includes, but is not limited to, a vinyl group, a hydride group, an acrylate group, a methacrylate group, a hydroxyl group, an allylic group, or combination thereof. In an embodiment, the bio-based oil includes a vinyl group, a hydride group, an acrylate group, or combination thereof. In an example, the soybean oil is functionalized with a vinyl group, an acrylate group, or combination thereof. In an example, the castor oil is functionalized with a hydride group. In an embodiment, the bio-based oil is non-functionalized.

Any reasonable amount of the bio-based oil is envisioned. For instance, the bio-based oil is present at an amount of 1 wt. % to 30 wt. %, such as 1 wt. % to 20 wt. %, or even 5 wt. % to 15 wt. % based on the total weight of the silicone composition. In a particular embodiment, the soybean oil is present at an amount of 1 wt. % to 30 wt. %, such as 1 wt. % to 20 wt. %, or even 5 wt. % to 15 wt. % based on the total weight of the silicone composition. In another particular embodiment, the castor oil is present at an amount of 1 wt. % to 25 wt. %, such as 1 wt. % to 15 wt. %, or even 1 wt. % to 10 wt. % based on the total weight of the silicone composition. It will be appreciated that the amount of bio-based oil can be within a range between any of the minimum and maximum values noted above.

With a conventional, commercially prepared silicone formulation, the commercially prepared silicone formulation typically includes components such as at least two organosiloxanes that polymerize in the presence of a catalyst, a crosslinker, a filler, and optional additives. In an embodiment, the bio-based oil replaces at least a portion of one of the components of the silicone composition to form the silicone polymer. For instance, the at least one organosiloxane polymerizes with the bio-based oil, i.e., the bio-based oil replaces at least a portion of a second organosiloxane that is typically used with a commercial formulation. As an example, a vinyl-containing alkylsiloxane is polymerized with the bio-based oil, the bio-based oil acting as a second organosiloxane in the polymerization reaction. In another example, a hydride containing alkylsiloxane is polymerized with a vinyl-containing bio-based oil, the vinyl-containing bio-based oil acting as the second organosiloxane in the polymerization reaction. In yet another example, at least two organosiloxanes are polymerized with the bio-based oil, i.e., the bio-based oil replaces at least a portion of a crosslinker that is typically used with a commercial formulation. In an example, a vinyl-containing alkylsiloxane and hydride-containing alkylsiloxane are polymerized in the presence of the bio-based oil, the bio-based oil acting as a crosslinker or chain extender in the polymerization reaction.

A filler may be further included in the silicone composition. The filler may include any reasonable filler that provides desirable properties such as, for example, viscosity during processing of the components of the silicone composition, mechanical strength, dimensional stability, and the like. In an embodiment, the filler includes silica, a pigment, a silicate clay, a recycled silica filler, a nanoclay, a bio-based filler, or combination thereof. In a particular embodiment, the filler includes a recycled silica, a nanoclay, a bio-based filler, or combination thereof. A “recycled silica filler” refers to silica filler obtained from recycling any of the following: post-industrial polymeric articles, pre-consumer polymeric articles, post-consumer polymeric articles, scrap polymeric articles, or any combination thereof. Any polymeric article is envisioned and includes, for example, a tubing, a bag, a connector, a septum, a nozzle, a closure, a valve, a sealant, an adhesive, a tape, a foam, a pad, a prosthesis, and the like. A “nanoclay filler” refers to nano clays, for example, layered mineral silicates, organized into classes such as montmorillonite, bentonite, smectite, kaolinite, hectorite, and halloysite. The nanoclay filler can include aggregated nanoclay particles (having a diameter from 20 nm to 500 nm) and exfoliated nanoclay (single platelets, which are typically about 1.0 nm in thickness but can extend hundreds of nanometers laterally). A “bio-based filler” as used herein refers to a plant-based filler, such as a silica filler derived from plant-based materials such as rice, wheat, bamboo, sugarcane, straw, barley husk, wheat straw, horsetail, sponges, oat hulls, corn stovers, nettle, hemp, mesa, and the like. The use of a bio-based filler, a recycled silica filler, or a nanoclay can further reduce the carbon dioxide emissions and the total carbon footprint of the silicone composition.

Any amount of filler is envisioned and when present, the total amount of filler in the silicone composition is in an amount of 1 wt. % to 45 wt. %, such as 5 wt. % to 40 wt. %, or even 10 wt. % to 30 wt. %, based on the total weight of the silicone composition. In an embodiment, the recycled silica, the nanoclay, or combination thereof is present at an amount of 1 wt. % to 45 wt. %, such as 5 wt. % to 40 wt. %, or even 10 wt. % to 30 wt. %, based on the total weight of the silicone composition. In an embodiment, the bio-based filler is present at an amount of 1 wt. % to 45 wt. %, such as 5 wt. % to 40 wt. %, or even 10 wt. % to 30 wt. %, based on the total weight of the silicone composition. It will be appreciated that the amount of filler can be within a range between any of the minimum and maximum values noted above.

In an embodiment, the silicone composition may further include a catalyst. Typically, the catalyst is present to initiate the crosslinking process. Any catalyst is envisioned depending upon the silicone composition. In an embodiment, the catalyst includes a hydrosilylation reaction catalyst. For instance, an exemplary hydrosilylation catalyst is an organometallic complex compound of a transition metal. In an embodiment, the catalyst includes platinum, rhodium, ruthenium, the like, or combination thereof. In a particular embodiment, the catalyst includes platinum. Further, other catalysts may be envisioned. Exemplary catalysts may include peroxide, tin, or combination thereof. In an embodiment, the catalyst may be present at greater than 0.1 wt. %, such as 0.1 to 5 wt. %, or even 1 to 3 wt. % of the total weight of the silicone composition. In a more particular embodiment, the catalyst is present at an amount of at least 0.1 wt. %, or at least 0.5 wt. %, or at least 1.0 wt. %, or at least 1.5 wt. %, or at least 2.0 wt. %, or at least 2.5 wt. %, or at least 3.0 wt. %, or at least 3.5 wt. %, or not greater than 5 wt. %, or not greater than 4.5 wt. %, or not greater than 4.0 wt. %, or not greater than 3.5 wt. %, or not greater than 3.0 wt. %, or not greater than 2.5 wt. %, or not greater than 2.0 wt. %, or not greater than 1.5 wt. % of the total weight of the silicone composition. It will be appreciated that the amount of catalyst can be within a range between any of the minimum and maximum values noted above.

The silicone composition may further include an additive. Any reasonable additive is envisioned. Exemplary additives may include, individually or in combination, a curing agent, a crosslinker, an adhesion promoter, an initiator, an inhibitor, a colorant, a pigment, a carrier material, an anti-microbial, or any combination thereof. An exemplary crosslinker is a silane compound. In an embodiment, the silicone composition is substantially free of an additive, such as present at less than 0.1 wt. % of an additive based on the total weight of the silicone composition. In some embodiments, the silicone composition consists essentially of the at least one organosiloxane, the bio-based oil, filler, crosslinker, and catalyst described above. As used herein, the phrase “consists essentially of” used in connection with the silicone composition precludes the presence of non-silicone polymers that affect the basic and novel characteristics of the silicone composition, although, commonly used processing agents and additives may be used in the silicone composition. In an embodiment, the silicone composition consists of the at least one organosiloxane, the bio-based oil, filler, crosslinker, and catalyst described above.

In an embodiment, the silicone composition has a number-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the number-average molecular weight of the silicone composition is 200,000 g/mol to 1,000,000 g/mol. It will be appreciated that the properties can be within a range between any of the minimum and maximum values noted above.

In an embodiment, the silicone composition has a weight-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the weight-average molecular weight of the silicone composition is 200,000 g/mol to 1,000,000 g/mol. It will be appreciated that the properties can be within a range between any of the minimum and maximum values noted above.

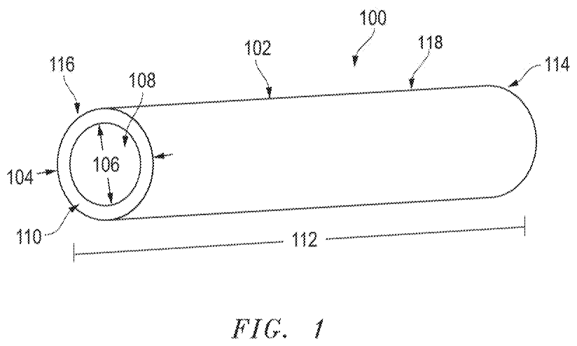

FIG. 1 is a view of an exemplary article, such as a tube 100 according to an embodiment. In a particular embodiment, the tube 100 can include a body 102 having an outside diameter 104 and an inner diameter 106. The inner diameter 106 can form an inner surface 108 of the body 102. The inner surface 108 defines a central lumen of the tube. In addition, the body 102 is illustrated as a single layer, the single layer including the silicone composition. The layer can include a thickness 110 that is measured by the difference between the outside diameter 104 and the inner diameter 106.

Any reasonable outside diameter 104 is envisioned. In a particular embodiment, the outside diameter 104 of the body 102 is about 0.09 inches (2.286 mm) to about 5 inches (127 mm). It will be appreciated that the outside diameter 104 can be within a range between any of the minimum and maximum values noted above. Any reasonable inside diameter 106 is envisioned. In an embodiment, the inner diameter 106 of the body 102 is about 0.005 inches (0.127 mm) to about 4 inches (101.6 mm), with the proviso that the inner diameter 106 is less than the outer diameter 104. It will be appreciated that the inner diameter 106 can be within a range between any of the minimum and maximum values noted above.

Further, the body 102 can have a length 112, which is a distance between a distal end 114 and a proximal end 116 of the tube 100. Any reasonable length 112 is envisioned. In a further embodiment, the length 112 of the body 102 can be at least 0.1 meters, such as at least 1 meter, such as at least 2 meters, such as at least 5 meters, or even greater than 10 meters. The length 112 is generally limited by pragmatic concerns, such as storing and transporting long lengths, or by customer demand. Further, the body 102 has a surface 118. The surface 118 can be an outer surface of the tube 100.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

Although illustrated as a single layer tube, any number of layers is envisioned. For instance, the tube includes one layer, two layers, three layers, or even a greater number of layers. Typically, the layer has a thickness of at least about 0.05 mm to about 10 mm. It will be appreciated that the thickness of the layer can be within a range between any of the minimum and maximum values noted above. Irrespective of the number of layers present, the outside diameter and inner diameter of the tube can have any values as defined for the single layer tube 100 defined in FIG. 1. The number of layers is dependent upon the final properties desired for the tube. Any configuration or location of the layer including the silicone composition is envisioned within the article.

In an embodiment, the silicone composition may be formed into a single layer article, a multi-layer article, or can be laminated, coated, or formed on a substrate. Multi-layer articles may include layers such as a polymeric layer, a reinforcing layer, an adhesive layer, a barrier layer, a chemically resistant layer, a metal layer, any combination thereof, and the like. When the article is a tube and the tube includes multiple layers, each of the individual layers of the tube may be formed by any reasonable means and is dependent upon the material and the configured location of each of the individual layers. Any number of layers is also envisioned. Although primarily described as a tube, the silicone composition can be formed into any useful shape such as film, sheet, tubing, and the like. The silicone composition may adhere or bond to other substrates including other polymers.

Any other polymer layer includes, for instance, an elastomeric polymer. Exemplary elastomeric polymers are envisioned and include, for example, a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a blend, or combination thereof.

In an embodiment, the silicone composition may be formed by any reasonable means depending upon the final article desired. In an embodiment, the silicone composition is formed into a tube by extrusion or injection molding followed by cure such as thermal cure, radiation cure, or combination thereof.

In an exemplary embodiment, the silicone composition is formed by an extrusion system. The extrusion system for the silicone composition typically includes a pumping system and can include a number of devices that can be utilized to form the article. For example, the extrusion system can include a pumping device such as a gear pump, a static mixer, an extruder, a tube die, a thermal cure device, a radiation cure device, a post-processing device, or any combination thereof. The method includes receiving, by an extrusion system, the mixed silicone composition as described above. Any reasonable mixing apparatus is envisioned. In a particular embodiment, the mixing apparatus forms a homogenous mixture of the at least one organosiloxane with a homogenous distribution of the bio-based oil. In an embodiment, heat may also be applied to the components of the silicone composition. For instance, any reasonable heating temperature for the components of the silicone composition may be used to provide a material that can flow from the pumping system and extruded through the tube die without degradation of the material. For instance, the temperature may be about 10 °C to about 70 °C. It will be appreciated that the heating temperature can be within a range between any of the minimum and maximum values noted above. Typically, the silicone composition is mixed and pumped, i.e., extruded, through the tube die of the extrusion system.

In an alternative embodiment, the article is formed by an injection molding system. The injection molding system includes any pumping system to deliver the silicone composition such as pneumatically, hydraulically, gravitationally, mechanically, and the like, or combination thereof. The pumping system delivers the silicone composition to a mold configured in any shape desired for the final article, such as a tube. The pumping system may also include any reasonable mixing apparatus envisioned. In a particular embodiment, the mixing apparatus forms a homogenous mixture of the at least one organosiloxane and the bio-based oil. Further, the pumping system may include a method of heating any combination of the components of the silicone composition to any temperature envisioned so that it has a desirable viscosity for delivery such that the silicone composition may flow into the mold. The injection molding system may further include a thermal cure device, a radiation cure device, a post-processing device, or any combination thereof.

In an embodiment, the silicone composition is thermally cured. In an embodiment, the thermal curing of the silicone composition can include subjecting the silicone composition to one or more heat sources. In a particular embodiment, the heat source is sufficient to substantially cure the silicone composition. “Substantially cure” as used herein refers to 90% to 100% curing degree, as determined for instance by rheometer data (90% cure means the material reaches 90% of the maximum torque as measured by ASTM D5289). For instance, the level of cure is to provide desirable properties for the final article.

In an embodiment, the silicone composition is radiation cured. Any number of applications of radiation energy may be applied with the same or different wavelengths. For example, the extrusion system or injection molding system can include one or more ovens (e.g., infrared (IR) ovens, air ovens), one or more baths (e.g., water baths), or a combination thereof, to cure the silicone composition. The one or more IR ovens can operate at a particular peak wavelength. In certain instances, the peak wavelength of a first IR oven can be different from the peak wavelength of a second IR oven. In an embodiment, the silicone composition can be subjected to a heat treatment for a specified period of time. In a particular embodiment, the silicone composition can be subjected to curing in a first IR oven for a first period of time and then subject to curing in a second IR oven for a second period of time that is different from the first period of time. In one particular embodiment, use is made of a short wavelength IR oven. By short wavelength, it is meant that the peak wavelength is below 4 microns, typically below 3 microns, such as within a range of approximately 0.6 to 2.0 microns, such as 0.8 to 1.8 microns. Generally medium and longer wavelength IR ovens are characterized by a peak wavelength on the order of 4 to 8 microns, or even higher. It will be appreciated that the wavelength can be within a range between any of the minimum and maximum values noted above.

Once the silicone composition is formed, the silicone composition can undergo one or more post processing operations. Any reasonable post processing operations are envisioned. For instance, the silicone composition can be subjected to a post-cure heat treatment, such as a post-curing cycle. Post thermal treatment typically occurs at a temperature of about 40 °C to about 200 °C. In an embodiment, the post thermal treatment is at a temperature of about 60 °C to about 100 °C. Typically, the post thermal treatment occurs for a time period of about 5 minutes to about 10 hours, such as about 10 minutes to about 30 minutes, or alternatively about 1 hour to about 4 hours. It will be appreciated that the post thermal treatment temperature and time can be within a range between any of the minimum and maximum values noted above. In an alternative example, the silicone composition is not subjected to a post thermal treatment. In an example, the article is a tube that can be cut into a number of tubes having a specified length. In another embodiment, the post processing can include wrapping the tube into a coil of tubing.

The article can be sterilized. In an embodiment, the article may be sterilized by any method envisioned. For instance, the tube is sterilized after it is formed. Exemplary sterilization methods include hydrogen peroxide, autoclave, gamma, ethylene oxide, electron beam techniques, combinations thereof, and the like. In a particular embodiment, the article is sterilized by gamma irradiation. For instance, the article may be gamma sterilized at between about 10 kGy to about 200 kGy. In a particular embodiment, the article is sterilized by steam sterilization. In an exemplary embodiment, the article is heat-resistant to steam sterilization at temperatures up to about 130 °C for a time of up to about 45 minutes. In an embodiment, the article is heat resistant to steam sterilization at temperatures of up to about 135 °C for a time of up to about 15 minutes. It will be appreciated that the sterilization parameters can be within a range between any of the minimum and maximum values noted above.

In an embodiment, the resulting article may have further desirable physical and mechanical properties. For instance, the article is flexible and kink-resistant. In particular, the resulting article has desirable flexibility. For instance, the silicone composition may advantageously produce low durometer articles. For example, an article having a Shore A durometer of between about 20 and about 90, such as between about 35 to about 75 as measured by ASTM D2240 having desirable mechanical properties may be formed. Such properties are indicative of a flexible material. In an embodiment, the silicone composition has at least one of the following properties: a) a tear strength greater than 25 KN/m, such as greater than 30 kN/m, or even greater than 35 kN/m, as measured by ASTM 624 (Die C no slit); b) an elongation at break of at least greater than 500%, such as greater than 600%, such as greater than 700%, such as greater than 800%, or even greater than 900%, as measured by ASTM D412 (Die C); or c) a tensile strength of at least 6.0 MPa, such as at least 7.0 MPa, such as at least 8.0 MPa, such as at least 9.0 MPa, or even greater than 10.0 MPa, as measured by ASTM D412 (Die C). It will be appreciated that the values can be within a range between any of the minimum and maximum values noted above.

In an embodiment, the use of the bio-based oil in the silicone composition decreases the carbon dioxide emissions footprint during the processing of making the precursor components compared to a silicone composition absent the bio-based oil. In an embodiment, the silicone composition has a carbon dioxide emission that is decreased by at least 5%, such as at least 10%, such as at least 15%, such as at least 20%, or even at least 25% compared to a silicone composition absent the bio-based oil. In a particular embodiment, the silicone composition has a carbon dioxide emission that is decreased up to 30% compared to a silicone composition absent the bio-based oil. The use of the bio-based oil to replace, for instance, at least one organosiloxane and/or a crosslinker provides a desirable silicone composition having a lower carbon dioxide emission compared to a silicone composition absent the bio-based oil. In a more particular embodiment, the use of a bio-based filler, a recycled silica filler, a nanoclay filler, or combination thereof may also decrease the carbon dioxide emissions footprint of the silicone composition. It will be appreciated that the values can be within a range between any of the minimum and maximum values noted above.

In exemplary embodiments, the article can be used in a variety of applications. Applications for the article are numerous. In particular, the non-toxic nature of the silicone composition makes the article useful for any application where toxicity is undesired. For instance, the article has potential for FDA, ADCF, USP Class VI, NSF, European Pharmacopoeia compliant, United States Pharmacopoeia (USP) compliant, USP physiochemical compliant, ISO 10993 Standard for evaluating biocompatibility of a medical device, and other regulatory approvals. In a particular embodiment, the silicone composition may be non-cytotoxic, non-hemolytic, non-pyrogenic, animal-derived component-free, non-mutagenic, non-bacteriostatic, non-fungistatic, or any combination thereof.

In an embodiment, the silicone composition is any formed into any reasonable article, such as the tube, that may be used in applications such as industrial, medical applications, health care, biopharmaceutical, drinking water, food & beverage applications, dairy applications, laboratory applications, FDA applications, and the like. In an exemplary embodiment, although the article is primarily described as a tube, the article of the present invention may include any geometry envisioned: a connector, a molded part, a septum, an infusion sleeve, a pump diaphragm, a membrane, a valve, and the like. Any article is envisioned where the physical and mechanical properties of the silicone composition are advantageous.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A silicone composition including at least one organosiloxane; at least one bio-based oil reactive with the at least one organosiloxane; and at least one filler.

Embodiment 2. A method of providing an article including a silicone composition including: providing at least one organosiloxane; at least one bio-based oil reactive with the at least one organosiloxane; and at least one filler; and shaping the silicone composition into an article.

Embodiment 3. An article including at least one layer of a silicone composition, wherein the silicone composition includes at least one organosiloxane; at least one bio-based oil reactive with the at least one organosiloxane; and at least one filler.

Embodiment 4. The silicone composition, the article, or the method of providing the article in accordance with any of the preceding embodiments, wherein the at least one organosiloxane includes a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

Embodiment 5. The silicone composition, the article, or the method of providing the article in accordance with embodiment 4, wherein the at least one organosiloxane includes a hydride-containing alkylsiloxane, a vinyl-containing alkylsiloxane, or combination thereof.

Embodiment 6. The silicone composition, the article, or the method of providing the article in accordance with embodiment 4, wherein the alkylsiloxane includes an alkyl group having any one of a C1-C6 group or combination thereof.

Embodiment 7. The silicone composition, the article, or the method of providing the article in accordance with any of the preceding embodiments, wherein the at least one bio-based oil includes a soybean oil, a castor oil, a macadamia nut oil, a palm kernel oil, an olive oil, a sunflower oil, a canola oil, a safflower oil, or combination thereof.

Embodiment 8. The silicone composition, the article, or the method of providing the article in accordance with embodiment 7, wherein the at least one bio-based oil includes a vinyl group, a hydride group, an acrylate group, a methacrylate group, a hydroxyl group, an allylic group, or combination thereof.

Embodiment 9. The silicone composition, the article, or the method of providing the article in accordance with any of the preceding embodiments, wherein the bio-based oil is present at an amount of 1 wt. % to 30 wt. %, such as 1 wt. % to 20 wt. %, or even 5 wt. % to 15 wt. % based on the total weight of the silicone composition.

Embodiment 10. The silicone composition, the article, or the method of providing the article in accordance with embodiment 9, wherein the soybean oil is present at an amount of 1 wt. % to 30 wt. %, such as 1 wt. % to 20 wt. %, or even 5 wt. % to 15 wt. % based on the total weight of the silicone composition.

Embodiment 11. The silicone composition, the article, or the method of providing the article in accordance with embodiment 9, wherein the castor oil is present at an amount of 1 wt. % to 25 wt. %, such as 1 wt. % to 15 wt. %, or even 1 wt. % to 10 wt. % based on the total weight of the silicone composition.

Embodiment 12. The silicone composition, the article, or the method of providing the article in accordance with any of the preceding embodiments, wherein at least a portion of the filler includes a recycled silica, a nanoclay, or combination thereof.

Embodiment 13. The silicone composition, the article, or the method of providing the article in accordance with any of the preceding embodiments, wherein at least a portion of the filler includes a bio-based filler.

Embodiment 14. The silicone composition, the article, or the method of providing the article in accordance with embodiment 13, wherein the bio-based filler includes a silica.

Embodiment 15. The silicone composition, the article, or the method of providing the article in accordance with any of the preceding embodiments, wherein the filler is present at an amount of 1 wt. % to 45 wt. %, such as 5 wt. % to 40 wt. %, or even 10 wt. % to 30 wt. %, based on the total weight of the silicone composition.

Embodiment 16. The silicone composition, the article, or the method of providing the article in accordance with embodiment 15, wherein the recycled silica, the nanoclay, or combination thereof is present at an amount of 1 wt. % to 45 wt. %, such as 5 wt. % to 40 wt. %, or even 10 wt. % to 30 wt. %, based on the total weight of the silicone composition.

Embodiment 17. The silicone composition, the article, or the method of providing the article in accordance with embodiment 15, wherein the bio-based filler is present at an amount of 1 wt. % to 45 wt. %, such as 5 wt. % to 40 wt. %, or even 10 wt. % to 30 wt. %, based on the total weight of the silicone composition.

Embodiment 18. The silicone composition, the article, or the method of providing the article in accordance with any of the preceding embodiments, further including a hydrosilylation reaction catalyst, a peroxide catalyst, a crosslinker, an inhibitor, or combination thereof.

Embodiment 19. The silicone composition, the article, or the method of providing the article in accordance with any of the preceding embodiments, wherein the silicone composition has a number average molecular weight of at least 50 g/mol, such as 50 g/mol to 1,000,000 g/mol, or even 200,000 g/mol to 1,000,000 g/mol.

Embodiment 20. The silicone composition, the article, or the method of providing the article in accordance with any of the preceding embodiments, wherein the silicone composition has a weight average molecular weight of at least 50 g/mol, such as 50 g/mol to 1,000,000 g/mol, or even 200,000 g/mol to 1,000,000 g/mol.

Embodiment 21. The silicone composition, the article, or the method of providing the article in accordance with any of the preceding embodiments, wherein the silicone composition has a tear strength greater than 25 KN/m, such as greater than 30 kN/m, or even greater than 35 kN/m, as measured by ASTM 624 (Die C no slit).

Embodiment 22. The silicone composition, the article, or the method of providing the article in accordance with any of the preceding embodiments, wherein the silicone composition has an elongation at break of at least greater than 500%, such as greater than 600%, such as greater than 700%, such as greater than 800%, or even greater than 900%, as measured by ASTM D412 (Die C).

Embodiment 23. The silicone composition, the article, or the method of providing the article in accordance with any of the preceding embodiments, wherein the silicone composition has a tensile strength of at least 6.0 MPa, such as at least 7.0 MPa, such as at least 8.0 MPa, such as at least 9.0 MPa, or even greater than 10.0 MPa, as measured by ASTM D412 (Die C).

Embodiment 24. The silicone composition, the article, or the method of providing the article in accordance with any of the preceding embodiments, wherein the article has a shore A durometer of about 20 to about 90, as measured by ASTM D2240.

Embodiment 25. The silicone composition, the article, or the method of providing the article in accordance with any of the preceding embodiments, wherein the silicone composition has a carbon dioxide emission that is decreased by at least 5%, such as at least 10%, such as at least 15%, such as at least 20%, or even at least 25% compared to a silicone composition absent the bio-based oil.

Embodiment 26. The article or the method of providing the article in accordance with any of the preceding embodiments, wherein the article includes a tube having an inner surface that defines a central lumen of the tube.

Embodiment 27. The article or the method of providing the article in accordance with embodiment 26, wherein the tube has an inner diameter of about 0.005 inches to about 4.00 inches.

Embodiment 28. The article or the method of providing the article in accordance with embodiment 26, wherein the tube has an outer diameter of about 0.09 inches to about 5.00 inches.

Embodiment 29. The article or the method of providing the article in accordance with any one of embodiments 2-28, wherein the article includes a connector, a molded part, a septum, an infusion sleeve, a pump diaphragm, a membrane, or a valve.

Embodiment 30. A tube comprising a silicone composition, the silicone composition including at least one organosiloxane; at least one bio-based oil reactive with the at least one organosiloxane, wherein the bio-based oil includes a soybean oil and a castor oil; and at least one filler.

Embodiment 31. The tube in accordance with embodiment 30, wherein the at least one organosiloxane includes a hydride-containing alkylsiloxane, a vinyl-containing alkylsiloxane, or combination thereof.

Embodiment 32. The tube in accordance with embodiment 30, wherein the soybean oil includes a vinyl group, an acrylate group, an allylic group, or combination thereof.

Embodiment 33. The tube in accordance with embodiment 30, wherein the at least one filler includes a recycled silica filler.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

The following samples were prepared as shown in Tables 1-8. The “40 duro silicone gum” was a 40 durometer (shore A) commercially available silicone high consistency rubber gum (HCR). The “60 duro silicone gum” was a 60 durometer (shore A) commercially available silicone high consistency rubber gum (HCR). The “catalyst masterbatch” was a platinum catalyst. The “hydride masterbatch” is a hydride silicone crosslinker in silicone gum.

TABLE 1
Control sample:

| Component | Wt. % |
|---|---|
| 40 duro silicone gum | 46.79% |
| 60 duro silicone gum | 46.79% |
| Catalyst masterbatch | 0.94% |
| Hydride masterbatch | 5.48% |

Comparative samples were compounded with soybean oil. With the soybean oil formulations, the soybean oil was functionalized with a vinyl, allylic, acrylate, or was not functionalized.

TABLE 2
Silicone composition with 4 wt. % Soybean oil

| Component | Wt. % |
|---|---|
| 40 duro silicone gum | 41.7% |
| 60 duro silicone gum | 41.7% |
| Soybean oil | 4.17% |
| Catalyst masterbatch | 2.02% |
| Hydride masterbatch | 10.41% |

TABLE 3
Silicone composition with 8 wt. % Soybean oil

| Component | Wt. % |
|---|---|
| 40 duro silicone gum | 39.65% |
| 60 duro silicone gum | 39.65% |
| Soybean oil | 8.11% |
| Catalyst masterbatch | 2.04% |
| Hydride masterbatch | 10.56%% |

TABLE 4
Silicone composition with 12 wt. % Soybean oil

| Component | Wt. % |
|---|---|
| 40 duro silicone gum | 37.67 |
| 60 duro silicone gum | 37.67% |
| Soybean oil | 12.05 |
| Catalyst masterbatch | 2.31% |
| Hydride masterbatch | 10.56% |

TABLE 5
Silicone composition with a non-functionalized
3.3 wt. % Castor Oil formulation

| Component | Wt. % |
|---|---|
| 40 duro silicone gum | 43.99& |
| 60 duro silicone gum | 43.99% |
| Castor oil | 3.34% |
| Catalyst masterbatch | 2.04% |
| Hydride masterbatch | 6.65% |

TABLE 6
Silicone composition with a non-functionalized
6.6 wt. % Castor Oil formulation

| Component | Wt. % |
|---|---|
| 40 duro silicone gum | 43.99& |
| 60 duro silicone gum | 43.99% |
| Castor oil | 6.68% |
| Catalyst masterbatch | 2.04% |
| Hydride masterbatch | 3.33% |

TABLE 7
Silicone composition with 3.3 wt. % castor oil +
4.0 wt. % vinyl functionalized soybean oil

| Component | Wt. % |
|---|---|
| 40 duro silicone gum | 41.90% |
| 60 duro silicone gum | 41.90% |
| Soybean oil | 4.19% |
| Castor oil | 3.32% |
| Catalyst masterbatch | 2.06% |
| Hydride masterbatch | 6.63% |

TABLE 8
Silicone composition with 8 wt. %
soybean oil + 3.3 wt. % castor oil

| Component | Wt. % |
|---|---|
| 40 duro silicone gum | 39.92% |
| 60 duro silicone gum | 39.92% |
| Soybean oil | 8.10% |
| Castor oil | 3.34% |
| Catalyst masterbatch | 2.06% |
| Hydride masterbatch | 6.67% |

The compositions were formed into samples and tested for mechanical properties. Samples were made using a two roll mill. Once milled, slabs were formed by curing the material at about 177 °C to about 200 °C under a pressure of about 22 psi. The material was post-cured for about two hours at about 177 °C. Elongation at break and tensile strength were tested via ASTM D412 (Die C); tear strength was tested via ASTM D624 (Die C no slit); and shore A was tested via ASTM D2240. Carbon dioxide (CO₂) emissions reduction was calculated with materials data from Sphera© Managed Life Cycle Assessment (LCA) content. Results were as follows:

TABLE 9

| | | Tensile | Tear | |
|---|---|---|---|---|
| | Elongation | Strength | Strength | Shore A |
| Formulation | (%) | (MPa) | (kN/m) | Hardness |
| Control | 885 | 10.8 | 33.8 | 44.5 |

TABLE 10
Soybean oil (4 wt. % comparison with amounts shown in Table 2)

| | | | | | CO₂ |
|---|---|---|---|---|---|
| | | Tensile | Tear | | Emissions |
| | Elongation | Strength | Strength | Shore A | Reduction |
| Formulation | (%) | (MPa) | (kN/m) | Hardness | (%) |
| Non- | 754 | 8.7 | 28.4 | 47.6 | 4.1 |
| functionalized | | | | | |
| Vinyl | 940 | 10.3 | 35.2 | 46.2 | 4.1 |
| Allylic | 621 | 6.8 | 37.9 | 48.5 | 4.1 |
| Acrylate | 683 | 7.7 | 39.6 | 47.4 | 4.1 |

TABLE 11
Soybean oil (loadings indicated in Tables 3 and 4)

| | | | | | CO₂ |
|---|---|---|---|---|---|
| | | Tensile | Tear | | Emissions |
| | Elongation | Strength | Strength | Shore A | Reduction |
| Formulation | (%) | (MPa) | (kN/m) | Hardness | (%) |
| 8% Non- | 746 | 7.9 | 28.8 | 45.8 | 7.8 |
| functionalized | | | | | |
| 8% Vinyl | 1013 | 9.5 | 32.5 | 44.6 | 7.8 |
| 12% Vinyl | 741 | 6.3 | 34.2 | 41.1 | 11.6 |

TABLE 12
Castor oil (loadings indicated in Tables 5 and 6)

| | | | | | CO₂ |
|---|---|---|---|---|---|
| | | Tensile | Tear | | Emissions |
| | Elongation | Strength | Strength | Shore A | Reduction |
| Formulation | (%) | (MPa) | (kN/m) | Hardness | (%) |
| 3.3% Castor oil | 839 | 9.9 | 33.9 | 45.2 | 3.1 |
| 6.6% Castor oil | 986 | 10.5 | 28.8 | 38.5 | 5.8 |

TABLE 13
Castor oil and soybean oil (loadings indicated in Table 7 and 8)

| | | | | | CO₂ |
|---|---|---|---|---|---|
| | | Tensile | Tear | | Emissions |
| | Elongation | Strength | Strength | Shore A | Reduction |
| Formulation | (%) | (MPa) | (kN/m) | Hardness | (%) |
| 3.3% Castor + | 844 | 9.3 | 33.6 | 41 | 8.3 |
| 4% soybean | | | | | |
| 3.3% castor + | 743 | 7.2 | 27.2 | 39.3 | 12.1 |
| 8% soybean | | | | | |

As shown in the Examples, the use of a bio-based oil provided a silicone composition with desirable mechanical properties.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A silicone composition comprising at least one organosiloxane; at least one bio-based oil reactive with the at least one organosiloxane; and at least one filler.

2. The silicone composition in accordance with claim 1, wherein the at least one organosiloxane comprises a hydride-containing alkylsiloxane, a vinyl-containing alkylsiloxane, an aryl-containing alkylsiloxane, a hydroxy-containing alkylsiloxane, a halogen-containing alkylsiloxane, or combination thereof.

3. The silicone composition in accordance with claim 2, wherein the alkylsiloxane comprises an alkyl group having any one of a C1-C6 group or combination thereof.

4. The silicone composition in accordance with claim 1, wherein the at least one bio-based oil comprises a soybean oil, a castor oil, a macadamia nut oil, a palm kernel oil, an olive oil, a sunflower oil, a canola oil, a safflower oil, or combination thereof.

5. The silicone composition in accordance with claim 4, wherein the at least one bio-based oil comprises a vinyl group, a hydride group, an acrylate group, a methacrylate group, a hydroxyl group, an allylic group, or combination thereof.

6. The silicone composition in accordance with claim 1, wherein the bio-based oil is present at an amount of 1 wt. % to 30 wt. %, such as 1 wt. % to 20 wt. %, or even 5 wt. % to 15 wt. % based on the total weight of the silicone composition.

7. The silicone composition in accordance with claim 1, wherein at least a portion of the filler comprises a recycled silica, a nanoclay, or combination thereof.

8. The silicone composition in accordance with claim 1, wherein the filler is present at an amount of 1 wt. % to 45 wt. %, such as 5 wt. % to 40 wt. %, or even 10 wt. % to 30 wt. %, based on the total weight of the silicone composition.

9. The silicone composition in accordance with claim 1, wherein at least a portion of the filler comprises a bio-based filler.

10. The silicone composition in accordance with claim 9, wherein the bio-based filler is present at an amount of 1 wt. % to 45 wt. %, such as 5 wt. % to 40 wt. %, or even 10 wt. % to 30 wt. %, based on the total weight of the silicone composition.

11. The silicone composition in accordance with claim 1, further comprising a hydrosilylation reaction catalyst, a peroxide catalyst, a crosslinker, an inhibitor, or combination thereof.

12. The silicone composition in accordance with claim 1, wherein the silicone composition has at least one of the following properties: a) tear strength greater than 25 KN/m, such as greater than 30 kN/m, or even greater than 35 kN/m, as measured by ASTM 624 (Die C no slit); b) an elongation at break of at least greater than 500%, such as greater than 600%, such as greater than 700%, such as greater than 800%, or even greater than 900%, as measured by ASTM D412 (Die C); or c) a tensile strength of at least 6.0 MPa, such as at least 7.0 MPa, such as at least 8.0 MPa, such as at least 9.0 MPa, or even greater than 10.0 MPa, as measured by ASTM D412 (Die C).

13. The silicone composition in accordance with claim 1, wherein the article has a shore A durometer of about 20 to about 90, as measured by ASTM D2240.

14. The silicone composition in accordance with claim 1, wherein the silicone composition has a carbon dioxide emission that is decreased by at least 5%, such as at least 10%, such as at least 15%, such as at least 20%, or even at least 25% compared to a silicone composition absent the bio-based oil.

15. A method of providing an article comprising a silicone composition comprising:
providing at least one organosiloxane; at least one bio-based oil reactive with the at least one organosiloxane; and at least one filler; and
shaping the silicone composition into an article.

16. An article comprising a silicone composition, the silicone composition comprising at least one organosiloxane; at least one bio-based oil reactive with the at least one organosiloxane, wherein the bio-based oil comprises a soybean oil and a castor oil; and at least one filler.

17. The article in accordance with claim 16, wherein the at least one organosiloxane comprises a hydride-containing alkylsiloxane, a vinyl-containing alkylsiloxane, or combination thereof.

18. The article in accordance with claim 16, wherein the soybean oil comprises a vinyl group, an acrylate group, an allylic group, or combination thereof.

19. The article in accordance with claim 16, wherein the at least one filler comprises a recycled silica filler.

20. The article in accordance with claim 16, wherein the article comprises a tube having an inner surface that defines a central lumen of the tube.
